(19) United States
(12) Patent Application Publication
(10) Pub. No.: US 2026/0359374 A1
(43) Pub. Date: Nov. 12, 2026

(54) MODULAR WEBPAGE COMPONENTS FOR SERVER-SIDE RENDERING OF DELIVERABLE WEBPAGE CODE

(71) Applicant: PAYPAL, INC., San Jose, CA (US)

(72) Inventors: Anush Vishwanath, San Jose, CA (US); Rohit Basu, San Jose, CA (US); Ryan Marshal Magoon, Raleigh, NC (US)

(21) Appl. No.: 19/201,443

(22) Filed: May 7, 2025

(51) Int. Cl. G06F 16/957; G06F 9/50

(52) U.S. Cl. CPC G06F 16/9577; G06F 9/5038

(57) ABSTRACT

There are provided systems and methods for modular webpage components for server-side rendering of deliverable webpage code. An online transaction processor or other service provider may provide computing services and platforms to entities including merchants for electronic transaction processing and other account services. To perform server-side rendering of webpage components in a modular manner, the service provider may provide a rendering system that may identify the webpage structure and jobs to be done, or tasks requiring execution, to properly render the webpage on a client device, such as in a browser. Each task may correspond to a component, such as a field, section, or portion of the webpage. An orchestrator may provide a unified interface to the different application interfaces and services necessary to obtain data for different components, which is then rendered by a rendered. Each component is streamed to the client device on rendering.

### TECHNICAL FIELD

The present application generally relates to webpages and webpage loading events on client devices, and more particularly to a rendering engine that dynamically generates and renders deliverable webpage code to client devices from server-side jobs.

### BACKGROUND

Online service providers may offer various services to end users, merchants, and other entities. This may include providing electronic transaction processing services, data flows, and other computing resources used to process transactions and payments electronically. Further, the service provider may provide and/or facilitate the use of their computing services with other online entities, and, as such, may provide data over a network for rendering on client-side computing devices. However, use of these client devices for interaction with the service provider may be limited by network latency, bandwidth, and the like, as well as the device's hardware, and the computing systems and/or architectures of the service provider, which may result in timed-out, dropped, or incomplete transactions. As such, the service provider must find efficient, fast, and optimized data loading processes, including data for webpages and/or other user interfaces (UIs) for the platforms and services of the service provider, without eliminating important information, service functionalities, and/or user personalization.

However, with client-side rendering of webpages and webpage elements, control of which elements are presented, where they are presented, and what the elements include are typically not possible server-side, as requests are sent to clients for processing and rendering using webpage components and the like. Further, conventional server-side rendering creates large data files that are then sent to client devices, encountering the issues with network speed, bandwidth, latency, and the like. These large data files may be created in a single job and/or responsive to a call from the client device, and therefore may be static, requiring a page reload or refresh to change content or other data in the webpage or other UI. Thus, there is a need to provide webpages and their corresponding elements on client devices in a fast and efficient manner using smaller data sizes and more configurable data files or packages, while maintaining the expected content and quality of current UIs. Further, there is a need to provide further customizability to building personalized and/or data-specific webpages for different calls and requests quickly and efficiently.

### BRIEF DESCRIPTION OF THE DRAWINGS

FIG. 1 is a block diagram of a networked system suitable for implementing the processes described herein, according to an embodiment;

FIGS. 2A-2C are exemplary diagrams for dynamic webpage building from modular components for server-side generation of webpage code, according to an embodiment;

FIGS. 3A and 3B are exemplary diagrams of calls exchanged between the different endpoints and/or components of a computing system that may dynamically build and deliver webpage code from a server-side rendering of a webpage using modular components, according to various embodiments;

FIG. 4 is a flowchart for modular webpage components for server-side rendering of deliverable webpage code, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for modular webpage components for server-side rendering of deliverable webpage code. Systems suitable for practicing methods of the present disclosure are also provided.

To utilize the computing services of online service providers, such as electronic transaction processors that may provide merchants and customers with digital accounts for payment processing, individual customers or end users, as well as employees, owners, agents, etc., of merchants or other entities, may access an online digital platform of the service provider. This may be done through a website accessed via a browser application on a client device of the user, or user interfaces (UIs) of a native software application on the client device. Typically, the manner in which a user interacts with an online service provider, such as a transaction processor for electronic payments and other electronic or digital financial transactions, services, and the like, is through websites and/or UIs of native/resident software applications. A browser application or the native software application may provide access to the webpages of the service provider's website and/or data for UI and UI element loading on a client device of the user.

After access to a digital platform of a service provider or other online business or entity, users may then avail themselves, via their client device, of the available products and computing services through data loaded on or in the webpages and/or UIs. For example, with an online transaction processor, users, including merchants or customers, can process transactions having an electronic payment to another user. The user may request processing of one or more transactions using a digital wallet or other account with the online service provider or transaction processor (e.g., PayPal®). Webpages and UIs provided by the transaction processor may be used for account setup and onboarding, login, authentication, payment processing, review, fraud reporting, and other computing services. For example, when accessing online platforms and utilizing the corresponding computing resources of a service provider, such as the aforementioned transaction processor, a user may proceed through a processing flow to setup and onboard for an account with the transaction processor that provides the user with access to the products and computing services during the course of transaction processing or other interactions with merchants, customers, and/or entities. However, as previously noted, load times remain a concern due to time consuming processes required for complex or highly detailed webpages, which is a concern for the fast times needed for transaction processing. Further, webpage loading is generally done in a prearranged order, which does not initially provide the user with the most relevant, important, or preferred information, webpage components, and the like, leading to poor UXs and potential drop off.

Conventional loading of webpages (or other UI to interact with the service provider's digital platform(s) and/or computing service(s), generally referred to as a UI herein) may be cumbersome and time consuming, without personalized loading based on the requesting user. In one or more embodiments described herein, a service provider may provide a dynamic and customized modular webpage experience through a dynamic rendering engine that may customize webpage building, assembly, rendering, and code delivery through a server-side rendering implementation. A modular webpage platform may be provided to handle incoming requests and/or other calls for loading a webpage of a website on a client device. This modular webpage platform may utilize modular webpage components for different fields, portions of the webpage, computing services or operations provided on the webpage, or other modular component used on a webpage that may be contained with a module usable to build or assemble that webpage and/or other webpages of the website. The webpage may be built and rendered server-side using these modular components, which may correspond to tasks or “jobs to be done” that need to be executed and/or performed in order for a presentation of the webpage to be rendered and output of the client device. Once the “jobs to be done” and/or other tasks have been performed for the requested webpage loading event, deliverable code may be sent to the user's client device through multiple responsive calls to the requesting call, with smaller data packages for these modular components of the webpage. As such, the webpage may be loaded faster for these components, such that transmission of a large data file that may cause bandwidth and latency issues can be reduced or eliminated.

In further detail, when a request is first received for loading a webpage on a client device, the request may be analyzed to determine the requester, the requirements or instructions for loading and/or presenting the webpage through the modular components, and the user-specific loading process, event(s), or calls that may be needed or identified for webpage loading. By correlating the jobs to be done for loading and presenting the webpage with the user, the webpage may be loaded faster and in a more personalized and optimized manner for that user, providing the user with the most important, relevant, or preferred webpage components, with less latency or error during loading. Each job to be done may correspond to a task and/or modular component for a portion, field, section, area, or the like of a webpage. A webpage may be built from multiple ones of these modular components, and therefore may have a structure, layout, and/or other information identifying the modular components usage for the webpage's rendering and/or presentation. Jobs to be done may be provided in a webpage code file or document or may be identified through their usage in a document object model (DOM) or other representation of the structure and content of the webpage.

As such, the jobs to be done (or tasks as referred to herein) for one or more webpages may be modularly separated and can be independently loaded with corresponding user data, through the webpage components. The webpage components may correspond to the actual coded components of task execution, such as code snippets or code packages, which may be executed for webpage rendering and may process user data for user-specific outputs on the webpage and in the corresponding webpage component's portion of that webpage. As such, tasks for loading and/or rendering the modular webpage components of a webpage may be provided in an instruction list, set of executables, or other webpage structure for webpage loading, and therefore may be loaded and/or executed to render the requested webpage. Each modular component for a task may correspond to an individual and separate module, but different modules of the modular webpage platform and/or website may also be interconnected and function together during webpage loading and/or presentation, for example, to affect each other during user input and use.

Once the tasks for webpage rendering and presentation are determined, execution of and rendering/loading the webpage components for each of the tasks may be customized for the user. For example, conventionally, tasks may be performed in their order according to an instruction set or executable code that may be followed. However, this leads to static loading and/or rendering of all webpage components together, resulting in the fastest loadable component loading at the same time as the slowest. Instead, according to various embodiments, information for the user's preferences, past usage of the webpage, modular components, and/or similar webpages, and the like may be used to load webpage components in an order and manner that may be the most helpful for the user. In this regard, the modular webpage platform may determine or predict what the user uses, needs to use, or values and finds important. To make these inferences and predictions, the modular webpage platform may utilize modular webpage components, or modular components herein, that make up the webpage, such as the elements, fields, menus, displayable content, interactable content and media, or other sections, portions, or parts of the webpage. Similar techniques can be used for UIs, for example, when rendering UIs server-side using modular UI components from a UI component library. A UI component library and/or modular Ui components may be used to modularly assemble UIs in a similar manner to webpages, as discussed herein. For example, similar to webpages, application UIs may include elements, fields, menus, displayable content, interactable content and media, or other sections, portions, or parts of the UI, which may be made modular and available in a component library and/or modular component form. These modular components and/or library may be used for UI assembly in a similar manner to webpages discussed herein.

A task for rendering of a webpage may identify one or more webpage components to load from a component factory or other modular component storage, and execute the corresponding code, functions, and processes. When determining how to present the webpage or other UI to the user in a modular manner, an artificial intelligence (AI) system and/or one or more AI models trained to predict user preferences for webpage component loading may be used to predict user preferences and/or usage of webpage components on the webpage, as well as a prioritization of webpage components for the user. The AI engine may provide a customized list, order, or the like to the webpage structure, which allows for loading and rendering of webpage components for a webpage in a user-specific order, thereby prioritizing important components and deprioritizing others for webpage code delivery.

In various embodiments, an AI engine used by the modular webpage platform for user-specific webpage component loading and rendering may include one or more AI models, such as machine learning (ML) models, neural networks (NNs), or the like, to determine a personalized and recommended order of assembling, rendering, and/or loading of the webpage's modular components on the client device of the user. Predictions, recommendations, or other inferencing performed for the user's prioritization of webpage components may be based on training knowledge of the AI engine, the webpage's structure or hierarchy of components, and the user's historical webpage usage information, preferences, and other relevant user data. Training of the AI engine (i.e., one or more AI models of the AI engine) may be performed using historical data for the service provider, webpage, and/or modular webpage components, as well as past patterns, usages, and the like, so that the AI engine may more accurately make inferences of future behavior from the past behaviors of users. As such, the AI engine may utilize trained ML models but may also or instead utilize rules for dynamic webpage rendering and customization. For example, rules may be used to enforce the usage and/or loading of certain components first or by a certain length of time since the request (e.g., a service level agreement (SLA) or the like), but may also correspond to and be generated based on regulatory requirements for webpages and/or data to be presented on certain webpages (e.g., laws, rules, and/or regulations), internal team or business requirements (e.g., risk, compliance, underwriting, etc.), and the like.

The rules may also be generated based on knowledge of successful and/or optimized or efficient webpage rendering. For example, with an online transaction processor, the transaction processor may have specific knowledge that an account balance is one of the most important webpage components to load first when loading a webpage for an account dashboard. As such, the rules may be generated to create, in real-time and responsive to client device requests, webpages that dynamically change, alter, and/or provide elements, features, and data on the webpage in a user-specific order. When the tasks for the modular components are executed, the tasks may also include or utilize user data or other dynamic data that may change based on the requester, time of request, location of request, or other variable factors for webpage loading requests. In this regard, the webpage components may be executed and rendered using information for the user and/or based on the parameters or other variable factors for the request, and such data may be automatically entered into the webpage component when rendered on the client device. Direct or indirect feedback from the user may also be used to optimize loading and presentation. For example, if the user engages with elements or content in a different order than presented or if the user skips over certain content, the system may use this to revise a similar rendering for a later transaction with the user. In another example, the user may be asked for specific feedback regarding whether the flow was sufficient or could be improved. This allows for the dynamic rendering engine to create a webpage from modular components to have webpage fields, portions, elements, or the like that have been rendered and loaded on the user's device in a streamlined and optimized manner.

For webpage rendering on the client device of the user, the dynamic rendering engine may create deliverable webpage code, such as hypertext markup language (HTML) or cascading style sheets (CSS) code, for the webpage and for transmission in multiple API calls. Each task, once identified and prioritized according to the user, may be executed by a webpage rendering engine to obtain a rendered version of the portion, field, element, or the like for the webpage and to be delivered to the user's device. The rendering engine may provide server-side rendering of the webpage components and may do so in an order and/or manner as determined based on the webpage structure and prioritization for the user, call, or the like. Multiple tasks may be run in parallel, and deliverable code, once generated from the execution of the tasks and rendering of the modular component, may be transmitted to the client device of the user for loading in the browser application or native software application requesting the webpage. By executing and rendering the modular components in parallel and delivering code as soon as completed, the webpage may be loaded in a faster manner with less API calls and less bandwidth bottleneck issues. The deliverable code may be sent to the client device of the user for loading in pieces and then assembled and rendered server-side so that the client device need only execute the code for presentation of the webpage, thereby removing the need for the client device to assemble and render from multiple different data packages or components.

Similarly, for UIs of native software applications, including mobile applications on mobile devices, the process can dynamically render application UI code server-side that may be delivered to the application for dynamic presentation. For example, a native application and experience may be coded in a coding language for native software applications, which may include coding UIs to have modular components, as discussed herein. As such, jobs to be done or executable tasks for UI rendering and presentation may be similarly coded and structured for execution with such modular components. UIs may therefore be rendered server-side for these applications, which may then be delivered as deliverable code for the native applications to execute and render corresponding UIs during runtime and/or use by users.

As such, by making the fields, areas, portions, available process, and other components of a webpage or other UI modular and contained within “jobs to be done” or tasks for webpage rendering and presentation, a service provider may provide a more efficient, reliable, and lower latency and/or bandwidth requirement engine and platform for loading webpages on client devices. The platform provides a responsive API and processor for handling webpage requests from navigations to webpages of a website in a faster manner by allowing multiple jobs to be done or tasks to run in parallel and provided to the client device on completion, not requiring a sequential processing and/or awaiting all task completions. Thus, users may view the prioritized webpage components first and faster than conventional webpage rendering techniques and engines. This further reduces the size of single data transmissions to multiple smaller calls that may be more easily handled and minimize bandwidth bottleneck issues. Further, since the execution of tasks may be user-specific, the user may view the most important, impactful, or desirable webpage components first and without having to wait for a full webpage load that may be time consuming and wasteful.

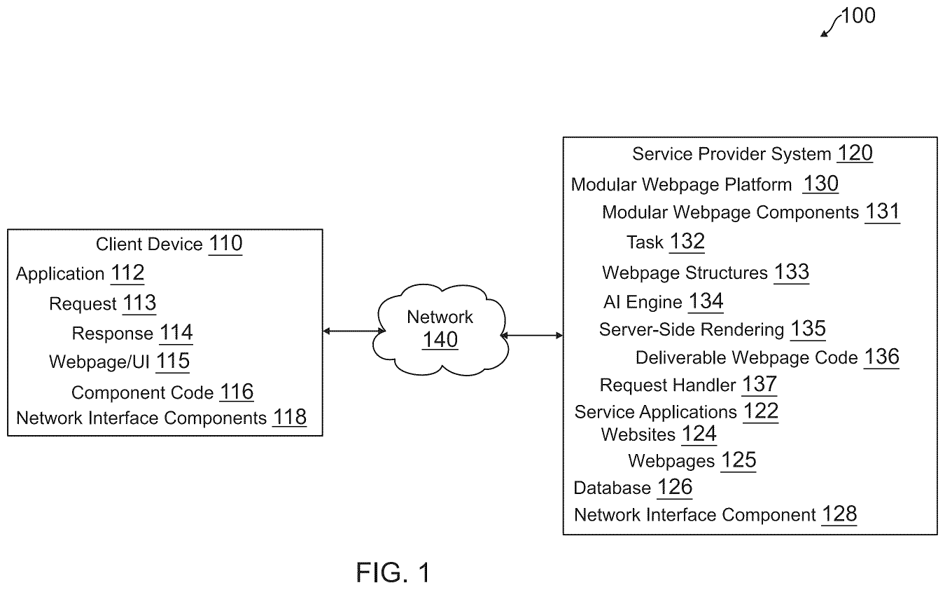

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider system 120 in communication over a network 140. Client device 110 may be utilized by a customer, entity, or other user of a service provider associated with service provider system 120. Client device 110 may be used by this user to receive communications over network 140, where service provider system 120 may provide various data, operations, and other functions over network 140 to provide services to merchants, users, and computing devices. In this regard, service provider system 120 may make these computing services available from one or more hosted websites, where webpages that make up the website may be rendered on client device 110 and/or other devices using a client-side rendering from modular webpage components, as discussed herein.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112 and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute modules and associated devices of client device 110 to provide a convenient interface to permit a user for client device 110 to request and browse webpages of websites including receiving modular loading and rendering of a webpage via webpage components from service provider system 120. In this regard, application 112 may correspond to specialized hardware and/or software utilized by client device 110 that may access one or more of websites 124 associated with service applications 122, request and receive webpage data for webpages 125 of websites 124, and display the webpage data for interaction, navigation, and the like. In some embodiments, application 112 may be used to provide transaction processing for goods and services (generally referred to as items), such as through a UI enabling the user to enter and/or view the items that the user associated with client device 110 wishes to purchase or access. This may be based on a transaction generated by application 112 using one or more merchant websites and/or transactions processing services associated with service applications 122. Application 112 may utilize user financial information, such as credit card data, bank account data, or other funding source data when providing payment information from stored data, logged in accounts, user input, and the like. Additionally, application 112 may utilize a digital wallet associated with an account with service provider system 120 as the payment instrument, for example, through accessing a digital wallet or account of a user through entry of authentication credentials and/or by providing a data token that allows for processing using the account. Application 112 may also be used to receive a receipt or other information based on transaction processing.

In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website, including payment information for the transaction. However, in other embodiments, application 112 may correspond to a native software application of service provider system 120 or other entity (e.g., a merchant), which may access online data for presentation via one or more UIs, which may be loaded and rendered from server-side rendering operations discussed herein. As such, when a user utilizes application 112 on client device 110, the user may cause a request 113 to be transmitted to service provider system 120 by application 112, such as in response to a navigation event, link selection or clickthrough, opening of a UI or window on a UI, or other input, action, or activity associated with requesting a webpage or other UI for display in application 112. In response, service provider system 120 may perform a modular rendering of the webpage based on tasks for webpage presentation, which may be executed by service provider system 120 to present the webpage on client device 110, as discussed herein.

In this regard, service provider system 120 may provide a response 114 to request 113, which may correspond to data received from one or more calls responsive to a call to service provider system 120 by application 112 (e.g., for a webpage of a website corresponding to service applications 122). Response 114 may include data from multiple responsive calls for the different modular components to be loaded for a webpage/UI 115 requested by application 112 from request 113. In some embodiments, response 114 may include deliverable webpage code, such as HTML or CSS code, which may be used to display webpage/UI 115 in application 112. In this regard, response 114 may be used to output and display rendered webpage components and data for webpage/UI 115. For example, component code 116 for each modular webpage component of webpage/UI 115 may be rendered server-side and delivered to client device 110. However, in other embodiments, response 114 may include deliverable application code for displaying or outputting a modular UI and modular UI components. In such embodiments, response 114 may correspond to receiving a stream of server-side rendered UI components and data for an application UI of a native software application, which may be streamed to application 112 for UI display and/or output. Component code 116 may therefore be modular and may allow display and output of the corresponding webpage or UI component when received instead of waiting on a single large file or another data transmission (e.g., a JavaScript file for a webpage or other file type/format for application UI code) for a webpage or UI to load in its entirety.

Although client device 110 is described as being associated with and/or utilized by a user to access a website associated with service applications 122, it is understood that client device 110 may be used by different types of users, and service provider system 120 may provide modular rendering services for different websites that service provider system 120 may host or provide over network 140. For example, a user may request a webpage of a merchant website provided by service provider system 120, which may be provided as discussed herein. Similarly, users working for or associated with different business entities and the like (e.g., employees of a merchant, company, or other business entity) may similarly utilize client device 110 to access webpages for different computing services provided via webpages of service applications 122.

Client device 110 may further include or have access to a database, which may correspond to different types of data storage and components including cloud computing storage nodes, remote data stores and database systems, distributed database systems over network 140, and the like used to store various applications and data. Database(s) used by and/or available to client device 110 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide computing services and operations via one or more digital platforms, applications, and the like accessible via websites and/or application UIs. Service provider system 120 may provide server-side rendering for webpages using a modular webpage component architecture and design so that webpages may be loaded in a faster, more efficient, and more user-friendly and intuitive manner. In other implementations, application UI code may be rendered server-side and delivered for different computer code that may be used to load modular UI components of an application UI. This may be done to reduce latency and bandwidth issues caused by conventional webpage rendering and display on computing devices, as well as provide important and/or preferred webpage components quickly so that users may interact with a webpage prior to fully outputting all webpage components. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes and/or is associated with a modular webpage platform 130, service applications 122, a database 126, and a network interface component 128, implementations of which are discussed further below. Modular webpage platform 130 and service applications 122 may correspond to executable processes, procedures, and/or applications with associated hardware. In other embodiments, service provider system 120 may include additional or different modules having specialized hardware and/or software as required.

Modular webpage platform 130 may correspond to one or more processes to execute modules and associated specialized hardware of service provider system 120 to provide a faster, more efficient, and more personalized rendering of components for a webpage or other UI displayable by clients to users for access to and/or use of the computing services, applications, and/or products of service provider system 120. In this regard, modular webpage platform 130 may correspond to specialized hardware and/or software used by a merchant or other user associated with client device 110 to provide operations for server-side rendering of webpages 125 for websites 124 using modular components for jobs that require execution, completion, and/or fulfillment to properly render a webpage. As such, modular webpage platform 130 may include applications, rendering engines, and other software processes for rendering of webpages 125 for websites 124 and transmission of deliverable webpage code, and well as modular webpage components 131 and webpage code for webpage component execution, rendering, and presentation in clients of users'devices. Modular webpage components 131 may be modularly created for different webpages and/or webpage functionalities and may be utilized by one or more webpages of a website. For example, modular webpage platform 130 may access modular webpage components 131 for webpage building in response to a request for a webpage to be presented in application 112 on client device 110. Modular webpage platform 130 may perform webpage building and rendering based on tasks 132 for webpages and webpage structures 133 that identify one or more of modular webpage components 131 for the webpage.

In this regard, modular webpage platform 130 may be used to specifically configure a webpage rendering for the client device requesting the webpage and/or the corresponding account or user requesting the webpage to be displayed on that device. For example, when client device 110 requests that webpage/UI 115 be rendered and provided for display in application 112 based on request 113, modular webpage platform 130 may determine tasks 132 that may be required or designated for execution and/or completion to render the webpage. Tasks 132 may correspond to executable processes, operations, or jobs, which may include modularly designed code and executables, that provide a corresponding webpage element, feature, or data that is included on the webpage. For different webpages of a website, webpage structures 133 may provide a listing, organization, or document of the corresponding webpage components used to build the webpage and/or included in the webpage. In some embodiments, webpage structures 133 may correspond to instructions for one or more of tasks 132 to be completed for webpage rendering. These aforementioned components may serve as the initial building blocks for webpage rendering when webpage requests are received from clients.

For handling of webpage and/or UI display or output requests, an AI engine 134 is used to provide intelligent decision making when performing a server-side rendering 135 for a webpage of a browser or a UI of a native application. AI engine 134 may include one or more AI models trained and/or configured to predict, infer, or determine prioritization of webpage/UI components for display, such as preferred webpage/UI components, location or time-sensitive webpage/UI components, and the like, which may affect an ordering for rendering and/or presentation of those corresponding components in the requesting client. For example, modularly designed webpages using modular webpage components 131 may be configured to be dynamically rendered by server-side rendering 135 for rendering and presentation of different components based on the prioritization of those components. This may allow each modular component to be separately rendered, where parallelization may be used to render multiple components at once, and deliverable code for the components may be sent to and presented in application 112 as soon as rendered. As such, AI engine 134 may be used to predict prioritization and/or other information used for ordered selection of webpage components during rendering.

In some embodiments, AI engine 134 may include rule-based engines and models created from one or more rules associated with webpage data content and/or presentation, including required webpage elements for presentation based on laws, regulations, SLAs, and the like. As such, AI engine 134 may determine webpage component loading based on rules for presentation of webpage elements, portions, or other modular data using modular webpage components 131 from a buildable component factory. As such, ordering of webpage component rendering and output, as well as which webpage components are displayed and/or where they may be displayed, may be changed, customized, and/or specifically built for user personalization during webpage rendering using modular webpage components 131, such as where, in what order, and what may be contained in data entry fields, menus, informational fields, options, navigation tools or links, and the like.

AI engine 134 may include one or more ML models, NNs, generative AIs, or other AI that may be trained and/or configured for modular webpage rendering and output using modular webpage components 131. AI models may have trained layers based on training data and selected features or data variables configured for prediction of user-specific or request-specific webpage rendering. For example, features or variables may be selected for model training and inferencing, which correspond to individual pieces, properties, characteristics, or other inputs for an AI model and may be used to cause an output by that AI model once the AI model has been trained using data for those features from training data. AI models and engines may encompass a broad categorization of different types of AIs, and within AIs, ML models may include different types of ML techniques, algorithms, and the like that may be used for computation and calculation of model scores based on layers, nodes, branches, clusters, rules, and the like that are trained and optimized. As such, ML models may be trained to provide a predictive output, such as a score, likelihood, probability, or decision, associated with a particular prediction, classification, or categorization. ML models may include broader classifications of models, such as clustering models and algorithms, decision trees, and the like. However, within ML models, NNs and other deep learning processes may involve more complex algorithms and networks of interconnected neurons that each may include mathematical representations of decisions being made for a predictive output.

ML models may be trained using training data, such as data records that have columns or other data representations and stored data values (e.g., in rows for the data tables having feature columns) for the features. When building ML models, training data may be used to generate one or more classifiers and provide recommendations, predictions, or other outputs based on those classifications and a model algorithm and architecture. As such, different types of AIs may be utilized by and/or included with AI engine 134 for execution and use with predictive performances of server-side rendering 135. As previously discussed, such AIs may include deep neural networks (DNNs), ML decision trees and/or ML clustering, LLMs and other generative AI, and other types of AI architectures. The training data may be used to determine features, such as through feature extraction and feature selection using the input training data.

Where AI engine 134 includes deep learning models, such as a DNN, models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN architecture for network training having one or more algorithms, computations, and/or techniques used to train the DNN. For example, each of the nodes in the hidden layer generates a representation, which may include a mathematical computation (or algorithm) that produces a value based on the input values of the input nodes. The DNN architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for networks or other models that attempt to classify and/or categorize the input feature data and/or data records. Thus, when a DNN of AI engine 134 is used to perform a predictive analysis and output, the input data may provide a corresponding output based on the trained classifications.

Layers, branches, clusters, or the like of the DNN may be trained by using training data associated with data records of interest, such as onboarding options, computing services, personalized assistance responses, available and/or required data for onboarding tasks and goals, and the like. By providing training data, the nodes in the hidden layer may be trained (adjusted) such that an optimal output (e.g., a classification) is produced in the output layer based on the training data. By continuously providing different sets of training data and/or penalizing the network (more specifically, penalizing or adjusting different neurons and/or synapses of the DNN) when the outputs are incorrect, the DNN(s) (and specifically, the representations of the nodes in the hidden layer) may be trained (adjusted) to improve its performance in data classifications and predictions. Adjusting of the DNNs may include adjusting the weights associated with each node in the hidden layer.

Server-side rendering 135 may correspond to one or more executable processes performed by a rendering engine for rendering webpages server-side, which may be done in place of client-side rendering. For example, with server-side rendering 135 for request 113, one or more of modular webpage components 131, and specifically the code, operations, and/or tasks for those components (e.g., tasks 132, or the “jobs to be done”), may be rendered server-side by modular webpage platform 130 through execution of the corresponding tasks and known or available data for the user and/or utilized by the components. Server-side rendering 135 may therefore provide a rendered version of a webpage, webpage/UI 115, as it should appear on client device 110 and/or based on the details of request 113. To provide that rendered version on client device 110, server-side rendering 135 may generate and/or extract deliverable code 136 for webpage/UI 115, such as HTML or CSS code that may cause a browser application to display that version of the webpage. As such, deliverable code 136 may be used to present webpage/UI 115 in application 112 and may include component code 116 modularly rendered and delivered for the corresponding webpage component. Similarly, server-side rendering 135 for native applications may perform server-side rendering of UI code for application UIs using modular UI components. The modular UI components may be rendered based on the tasks required to be performed or executed to load those components. Rendering may similarly use the user data and/or data requested by those components during execution to render computer code executable to cause a display or output of the UI in the native application. Once rendered, application executable code for UI presentation or display may be generated and streamed to client device 110.

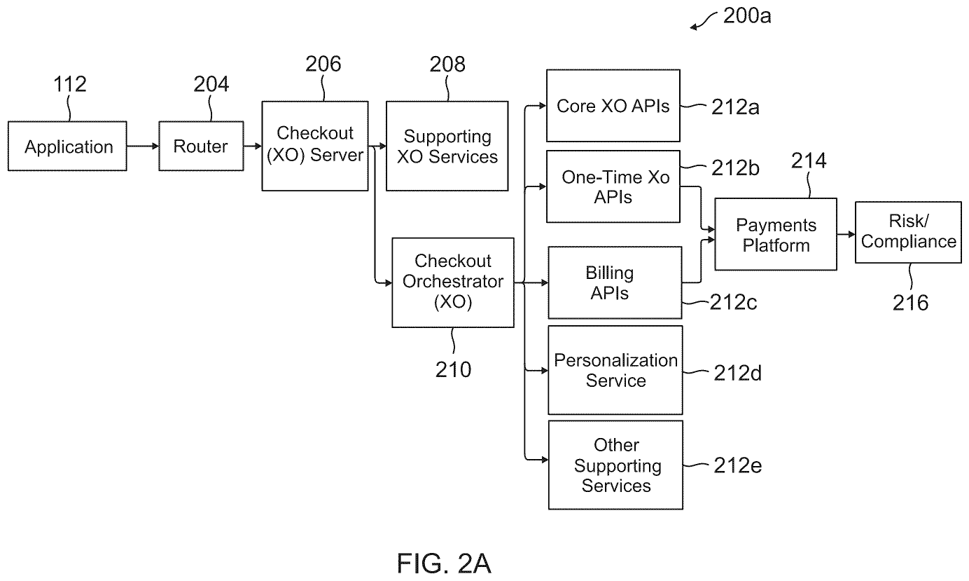

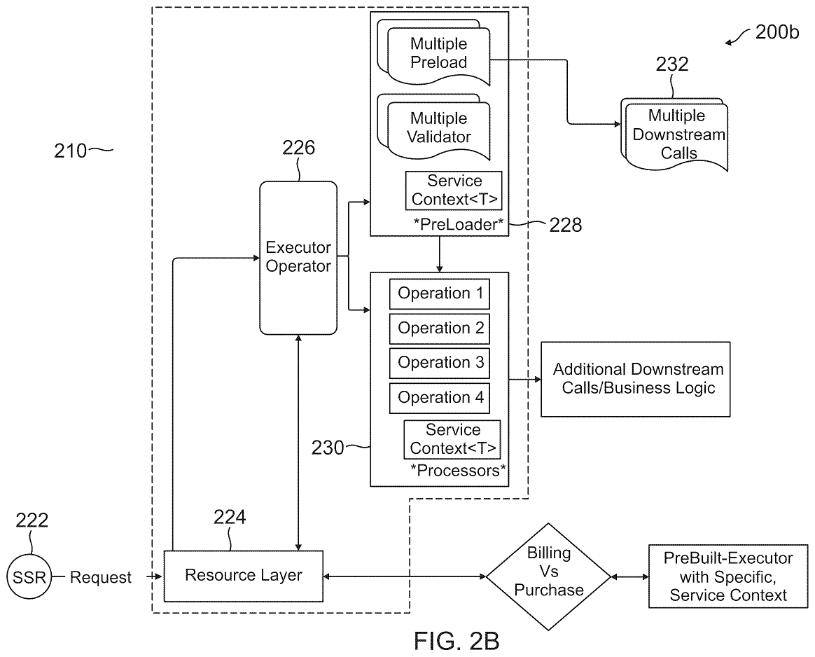

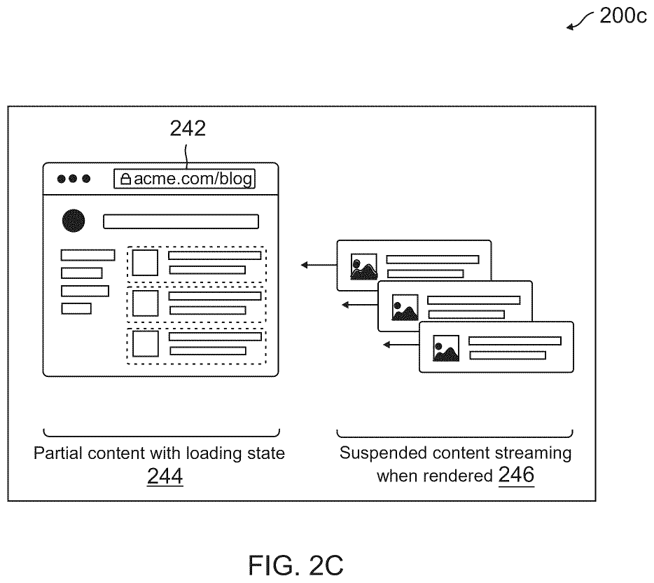

Since the webpage components of webpage/UI 115 are modular, deliverable code 136 may correspond to one or more snippets, sections, or self-contained webpage modules of a webpage, which may be sent in multiple parts and calls to client device 110 and presented via component code 116 when received. For example, during checkout for a transaction and processing of an electronic payment, a checkout window may be rendered as quickly as possible and delivered to client device 110. In some embodiments, deliverable code 136 may be generated by parallel processes, and therefore may arrive at the same or different times. While modular webpage component rendering discussed herein may refer to webpage rendering in the context of online transaction processors and other service providers, it is understood that the modular webpage rendering system may be utilized with different webpage hosts and/or hosting platforms, Internet service providers, as the like. The operations for modular webpage components, design, and rendering are discussed in further detail with regard to FIGS. 2A-4 below.

Service applications 122 may correspond to software applications, platforms, and/or operations executable using corresponding hardware of or accessible to service provider system 120. Service applications 122 may be used to provide computing services to users over network 140, and therefore may be accessible by client device 110 and/or other devices, servers, and/or requesters via one or more of websites 124 and/or UIs in native software applications, which may display corresponding ones of webpages 125. Where service provider system 120 may correspond to an online transaction processor, service applications 122 may include one or more transaction processing applications and/or payment applications that may process a transaction and/or provide other computing services for electronic transaction processing and payments to users, merchants, and the like, as well as financial or payment account establishment, maintenance, and usage. A payment account may be accessed and/or used through a browser application and/or dedicated payment application executed by client device 110, such a payment and/or digital wallet application. The transaction processing application may process payments and may provide transaction histories to client device 110 and/or another user's device or account for transaction authorization, approval, or denial of the transaction for placement and/or release of the funds, including transfer of the funds between accounts.

As such, service applications 122 may host or utilize webpages 125 accessible by client devices of users, as well as provide UI data for software application, over network 140, which may require modular component rendering as discussed herein. Websites 124 include webpages 125 corresponding to the individual and accessible pages that may be able to be rendered and output for viewing in clients when requested. As such, webpages 125 may make up the corresponding ones of websites 124, and webpages 125 may be rendered in accordance with the modular webpage rendering processes described herein.

Further, service applications 122 may provide different computing services, including social networking, microblogging, media sharing, messaging, business and consumer platforms, etc. These computing services may be used by merchants, customers, and other users or entities, where presentation of webpages and other UIs may be modularly rendered and sent to clients by modular webpage platform 130. Service applications 122 may provide additional features to service provider system 120 for internal and/or external systems, processors, and the like. For example, service applications 122 may include security applications for implementing server-side security features, programmatic client applications for interfacing with appropriate application programming interfaces (APIs) over network 140, or other types of applications. Service applications 122 may include additional connection and/or communication applications, which may be utilized to communicate information to over network 140.

Additionally, service provider system 120 includes or may access database 126. Database 126 may store various identifiers associated with client device 110 and/or other devices and/or servers that may engage and/or interact with accounts, computing services, and/or onboarding processes. Database 126 may also store account data, including payment instruments, financial information, account balances, and authentication credentials, as well as transaction processing histories and data for processed transactions. Database 126 may include information used during merchant onboarding. Although database 126 is shown as residing on service provider system 120 as a database, in other embodiments, other types of data storage and components may be used including cloud computing storage nodes, remote data stores and database systems, distributed database systems over network 140 and/or of a computing system associated with service provider system 120, and the like.

Service provider system 120 may include at least one network interface component 128 adapted to communicate with client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2C are exemplary diagrams 200a-200c for dynamic webpage building from modular components for server-side generation of webpage code, according to an embodiment. Diagrams 200a-c include components of service provider system 120 that may be utilized for dynamic and modular webpage building and rendering for personalized and user-specific webpage presentation on client device 110, as discussed in reference to system 100 of FIG. 1. In this regard, diagrams 200a-c may represent the interactions, flow, and execution of calls between such components when determining webpage components for tasks requiring performance to load and render the webpage for presentation in a browser application or other software applications running on client computing devices.

Referring now to diagram 200a of FIG. 2A, layers and components for modular webpage building and rendering are shown, which may be used when configuring and rendering a webpage for presentation on a client device, such as in a application 112 or native application 202. Modular webpages may be used to provide webpage content and services to users in a modular design, enabling webpage rendering to occur server-side with parallelization for processing of different modular components of that webpage. For example, during online checkout for a transaction, a checkout processing flow may include one or more webpages where a user may review information, select a payment instrument, and/or otherwise engage in the processes for transaction processing.

A checkout webpage may be modularly designed to include different components necessary for online or digital checkout and electronic transaction processing. In such an example, a checkout webpage may include an account login field or process, a transaction review process, a shipping/billing information form, as well as other less obvious webpage components corresponding to the presented elements, fields, and data on the webpage (e.g., merchant contact information, discount code fields, etc.). Application 112 may display the webpage modularly as each component is rendered and provided to application 112 instead of waiting for a full-page render for webpage display. In some embodiments, application 112 is discussed in reference to system 100 of FIG. 1 as a browser application, which may display webpages. However, a native software application, including mobile applications, may correspond generally to application 112 in system 100 of FIG. 1, which may utilize in-app UIs and/or web views of webpages presented through modular UI or webpage, respectively, component building and rendering discussed herein. In diagram 200a, application 112 may reside in a checkout client layer, which may provide a checkout client on client devices that include the assets run in a corresponding application of the client devices. This layer may receive and react to user actions, and based on the action, call checkout server 206 or other API.

For a modular checkout webpage or any other webpage designed using modular components for server-side rendering, a request for the webpage from application 112 may arrive at a router 204 that routes traffic on behalf of the service provider or entity providing the webpage such that the webpage request is provided to a checkout server 206 for checkout webpage and other UI handling and serving to requesting clients. Checkout server 206 may provide a front end and/or connection layer through which client devices and other requestors may connect with supporting services 208 and a checkout orchestrator 210 for checkout processing needs and/or requirements. Checkout server 206 may correspond to a layer that includes a rendering engine or other operations to render webpage components into HTML code or other deliverable webpage code for the client layer and for presentation via application 112. As such, the layer for checkout server 206 may identify the experience to be rendered based on the webpage request and corresponding modular webpage to the user and/or by the requesting client and may collect data necessary from checkout orchestrator 210 for rendering into the appropriate experience using server-side rendering and transmission of deliverable code.

Supporting services 208 may provide additional supportive services for checkout and/or modular checkout or webpage rendering. Checkout orchestrator 210 may serve as the layer to connect the data needs and/or computing services of the transaction processor for modular checkout that are supported by the front end (e.g., products offered by checkout server 206 and/or utilized in application 112). In this regard, checkout orchestrator 210 may serve as a unified interface and connection service between the webpage and webpage user experience (UX) provided through the modular webpage components and the downstream core services and APIs callable by such components (e.g., for a checkout UX on a checkout webpage). Although referred to as a “checkout” orchestrator or orchestration, checkout orchestrator 210 may be similarly used and/or designed for orchestration of different UX provided through modular webpage components that may be built and rendered server-side, as discussed herein.

Checkout orchestrator 210 may provide an orchestration layer for checkout server 206 to connect with when providing a checkout UX via a webpage. Checkout orchestrator 210 may unify the downstream services and APIs to call for webpage rendering, such as providing a single interface for APIs and services 212a-212e including core checkout (XO) APIs 212a, one-time XO APIs 212b, billing APIs 212c, a personalization service 212d, and other supporting services 212e. For example, checkout orchestrator 210 may connect with both one-time XO APIs 212b and billing APIs 212c for one-time checkout and billing agreement use cases, respectively, as well as other services for different UX flows and options. As such, checkout orchestrator 210 may provide a flow-specific interface when required. Further downstream, APIs and services 212a-e may further connect with additional APIs and services.

For example, for modular checkout webpages, one-time XO APIs 212b and billing APIs 212c may connect with a payments platform 214 and a risk/compliance service 216. Payments platform 214 may correspond to an orchestration server and/or computing service that may orchestrate, process, and provide payments with different parties, such as by processing a financial instrument for a customer or other payer and providing a payment to a merchant or other payee. Thus, payments platform 214 may be called to obtain payment information for modular components on webpages and/or in UIs of native applications, as well as process input from the components and provide payment processing results and other information rendered in the components. Risk/compliance service 216 may provide a risk and fraud detection service, compliance monitoring and/or enforcement, and other practice to reduce fraud, noncompliance with rules, laws, or regulations, and/or other enforcement procedures. As such, risk/compliance service 216 may be used to assess risk or fraud associated with one or more payments.

For management and execution of checkout orchestrator 210, certain assumptions may be made for proper functionality. Checkout orchestrator 210 may connect to different core services and domain/product APIs to fulfill the UX requirements of the webpage and webpage component and is capable of abstracting the domain complexities for the corresponding domain. In this regard, APIs and services 212a-e may be agnostic of their underlying processing stack and should abstract these processing complexities for interfacing with checkout orchestrator 210. Thus, checkout orchestrator 210 may not be asked or required to reintegrate for the processing stack migrations and each product layer. Further, checkout orchestrator 210 may not perform business needs to specific products, and as such, APIs and services 212a-e may maintain business logic at their corresponding product layer and use the connected services and API further downstream. Additionally, checkout orchestrator 210 may not be required to or be provided access to the data owned by domains to avoid data ownership issues, and as such, APIs and services 212a-e may handle and process domain-specific data before responding to or on request from checkout orchestrator 210, eliminating the need to exchange that domain-specific data.

As such, checkout orchestrator 210 may include one or more APIs that support the corresponding experience provided via the webpage(s) having modular components. Checkout orchestrator 210 may correspond to a layer that interacts with different product capability APIs, core APIs, and/or services of APIs and services 212a-e to provide data needed to render different experiences to consumers. For example, checkout orchestrator 210 may host and utilize shipping address related APIs and directly connect to user services for shipping address related information if a modular component for such a service is added to a webpage (e.g., if a webpage component for the shipping address related APIs is utilized).

In diagram 200b of FIG. 2B, an execution framework of checkout orchestrator 210 is shown in further detail. Diagram 200b shows the calls and interactions between the layers and other components of and/or used by checkout orchestrator 210 from diagram 200a. In this regard, although the processes for checkout orchestration of webpage components for modular webpage rendering are discussed, orchestration of webpage rendering for modular webpage components may similarly be performed for other tasks, domains, and/or webpages. As such, the execution framework of checkout orchestrator 210 in diagram 200b may be applied to other server-side rendering processes.

Checkout orchestrator 210 may initially interact with a server-side rendering (SSR) 222 that may request data for rendering a webpage on a client device. The request may identify the webpage, and checkout orchestrator 210 may determine the webpage components, processing parallelization and ordering/sequence of webpage component execution and processing for rendering, and other tasks or jobs for rendering each webpage component of the webpage requested. Rendering of components may be performed individually, but parallelization of processing may allow for multiple components to be determined, built, and rendered at the same time. As such, SSR 222 may interface with a resource layer 224 and transmit a request/call to resource layer 224 for data necessary for SSR 222 to render webpage components in a modular manner for client-side presentation of a webpage.

Since checkout orchestrator 210 may query multiple different APIs, services, and/or other resources when obtaining data for modular checkout building on a webpage or in another UI, checkout orchestrator 210 may be required to interface with multiple query resolvers in a single query or mutation (in GraphQL), and each of these may require the same or similar set of data either in synchronous manner or concurrently. To do so, a request is received at resource layer 224 to create a ServiceContext or other class or set of information to the query being generated for multiple resolvers, and a resource is built for that class. In this regard, the resolvers may correspond API functions that may populate data for a particular field and may correspond to other types of query and/or code languages utilized by APIs. Each ServiceContext may be associated with a particular query or mutation, but a query or mutation may have more than one ServiceContext, where each may hold and/or utilize different resources for query resolution. An executor 226 may correspond to a builder that utilizes multiple pre-loaders, validators and processors with a specific ServiceContext. This may be done so that an instance of executor 226 for a particular resolver and has all the information on the execution path for that particular query or mutation.

Since the instances are injected on application startup, there may always be at least a single instance of executor 226. Executor 226 may receive the ServiceContext creation request from resource layer 224 and manage the processing and response, such as by providing the data for the corresponding webpage components from the downstream services used. Although the resolvers are discussed as being coded for and utilized with GraphQL as a query language for APIs, any query language and/or corresponding code for APIs may be utilized. As such, the queries for the resolvers may be specified by the API specification and may be in any corresponding language or form that may be utilized by APIs when fetching data or querying databases and/or other endpoints for data. The queries for the resolvers to execute with the executors may be specified in the API specification so that the queries may be properly coded for the different resolvers that are to be used for different data loading tasks.

Pre-loaders 228 may correspond to a component that loads data prior to performing any process or transformation on the data. Pre-loaders 228 may correspond to a bridge between business logic and downstream calls which are capable of connecting to a single downstream component or multiple downstream components to process or transform data. Processors 230 may correspond to the main function of checkout orchestrator 210, which may include multiple different smaller functions or a single function for certain resolvers. As such, each of processors 230 may be open ended by design because each one of processors 230 may be different for each query and mutation. In some embodiments, processors 230 are not shared between different executors as each of processor 230 may be tied to a specific ServiceContext, and each ServiceContext tied to a specific query or mutation. This is to separate out concerns for different queries and have precise and concise code blocks that define a particular behavior

Processors 230 may perform the query mapping for the incoming query to the output in the response data class. This allows checkout orchestrator 210 to isolate a particular query's execution to a corresponding one of processors 230. Processors 230 may access data using multiple ones of pre-loaders 228. The implementation and the mapping aspect of the query will be defined by each processor. Any incoming request may have a ServiceContext that includes the token and any headers. These fields may further be configurable and changed for different requests and may be required for the particular query or mutation used for webpage component data loading. As such, a Request DataClass and a Response DataClass may be optional or may identify the data classes of the request/response. Since omitting a Response DataClass is rare, it may be set to a record object or data class for the return object for a particular query or mutation. Checkout orchestrator 210 may further interact with delegates 232, which may represent the downstream service calls. Each delegate may be a single function or a set of functions representing different service and/or API calls. Delegates can be used in tandem with pre-loaders 228, or it can be used by processors 230. Delegates 232 may each include a job to connect with and/or provide a connection with the downstream API or service to facilitate the call for data queries for webpage component building and rendering.

Diagram 200c of FIG. 2C shows a representation of a webpage 242 and webpage components 244 modularly configured to be rendered in parallel and presented when rendered on a client device. For example, webpage 242 may correspond to a page corresponding to a website having a domain and domain name of one or more accessible pages. In this regard, the elements, fields, menus, and/or data on webpage 242 may provide information and/or additional functionalities to users and may be rendered and/or presented on webpage 242 using webpage components 244. For example, webpage components 244 may include a login field, webpage content, host information, and the like. Webpage components 244 may be rendered as a result of executing and/or performing tasks 246, such as jobs that can be done or performed for webpage presentation on a device. Tasks 246 may be established for webpage 242, such as in DOM file or other webpage data, as well as through the use of webpage components 244 when creating and/or updating webpage 242.

Tasks 246 may be designed to be both modular and independent from other tasks and reliance on other webpage components for rendering. As such, tasks 246 may be performed in parallel, and different ones of tasks 246 may be rendered prior to other ones. On completion, tasks 246 may be streamed to the client device requesting webpage 242 for output. As such, tasks 246 may be transmitted to the client device requesting webpage 242 for partial content loading, such as in a loading state, while additional ones of webpage components 244 are rendered server-side using checkout orchestrator 210 or a similar orchestration layer. As such, tasks 246 may stream content for presentation of webpage components 244 when available and rendered. Generally, tasks 246 may be performed in a specified order based on webpage design, available resources, and the like. However, AI engine 134 may provide intelligent task performance and content streaming so that the most relevant and useful content is loaded in webpage 242 first.

For example, webpage 242 in diagram 200c may correspond to a checkout webpage having modular checkout components. There may be checkout product capability APIs responsible for providing the domain capabilities including funding options for billing, funding options for one-time checkout, approval for one-time checkout transaction, and/or approval for billing agreement creation. Core checkout APIs may also provide domain capabilities irrespective of the checkout product, and may include payee details API, cart API, supported payment methods, currency conversion APIs, application data APIs, and the like. All these core APIs may be hosted by and/or connected with checkout orchestrator 210 so that calls designated for these downstream APIs and services may be performed by checkout orchestrator 210 to deliver data for tasks 246 and render webpage components 244. While diagram 200c is shown presenting webpage 242, in other embodiments, the components that are modularly rendered and streamed for display in diagram 200c may instead correspond to an application UI of a native software application, such as a mobile application on a mobile device or the like.

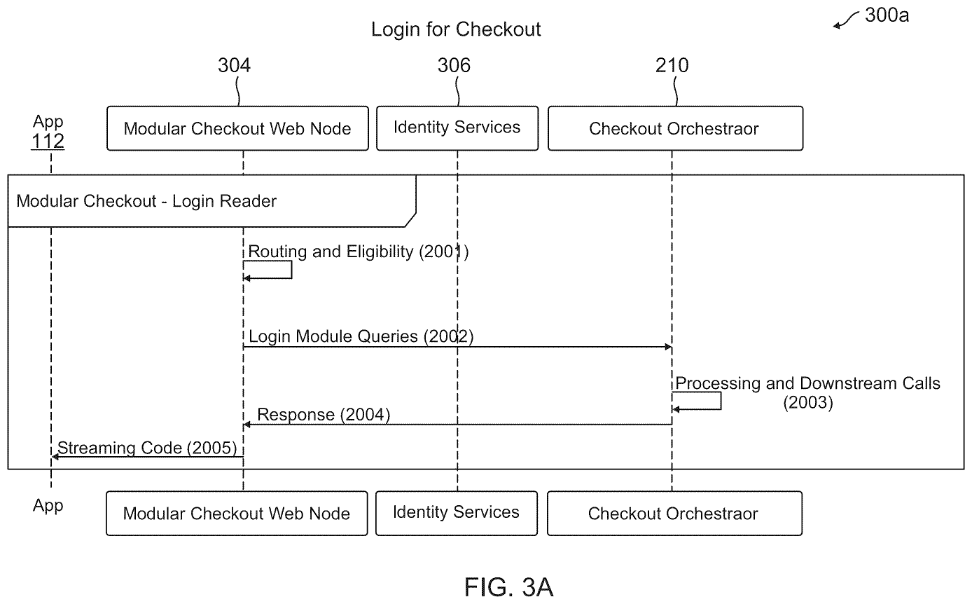

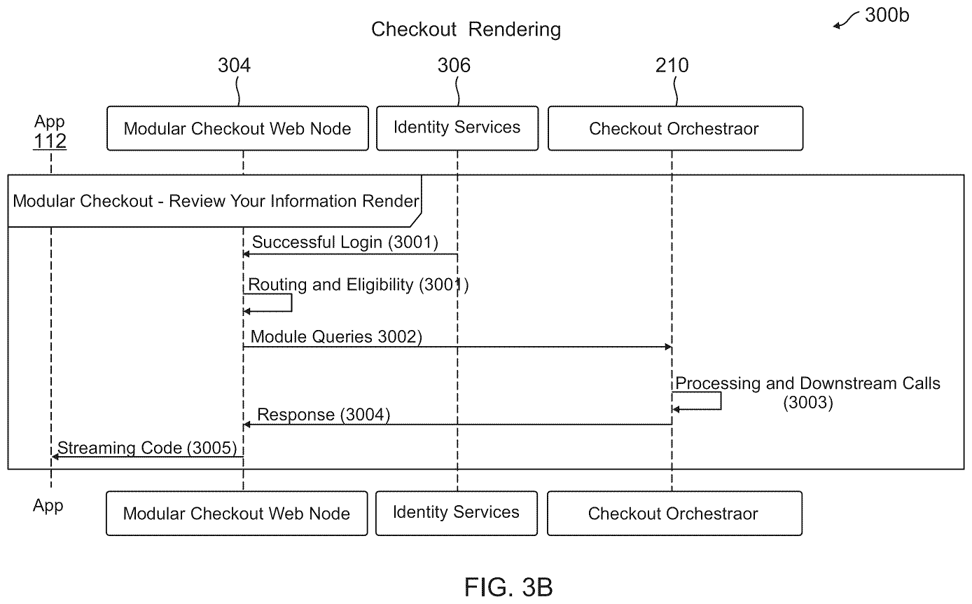

FIGS. 3A and 3B are exemplary diagrams 300a and 300b of calls exchanged between the different endpoints and/or components of a computing system that may dynamically build and deliver webpage code from a server-side rendering of a webpage using modular components, according to various embodiments. Diagrams 300a and 300b may correspond to the calls or other interactions occurring as a result of a request for display of a webpage in a browser, such as a request for a webpage to be presented in application 112 on client device 110 in system 100 of FIG. 1. Diagrams 300a and 300b may be displayed responsive to server-side rendering of webpage components in a modular manner and for streaming as rendered components become available. As such, diagrams 300a and 300b may correspond to the calls exchanged between application 112 and modular webpage platform 130 of service provider system 120 for webpage loading in the corresponding browser.

In diagram 300a, a login webpage component for a modular webpage and webpage components is rendered and streamed to application 112 for a presentation to a user. For example, application 112 may request display of a webpage, UI, or the like on client device 110 during operation and runtime. As such, application 112 may correspond to a web browser configured to access the Internet or other network and retrieve webpage data for display of the webpages of different websites, but may instead correspond to native software applications displaying application UIs based on server-side data. In this regard, application 112 may perform or execute a navigation event to a website and/or web address of a webpage, or a call to an API, network address, or the like of a server or other endpoint that may provide UI data. Thus, application 112 may transmit a request for the corresponding webpage and webpage data or UI and UI data to service provider system 120, which may be handled using modular webpage platform 130.

Application 112 may initially interact with a modular checkout web node 304 in diagram 300a, which may provide a web-based processing node for execution of certain tasks and coordination of communications and data exchanges with different devices, servers, and the like of a network, such as the Internet. In this regard, modular checkout web node 304 may provide modular checkout webpages and other UIs and UI elements via the processing node available on the web or other network. To facilitate connections to the internal service and processors of the transaction processor or other service provider, modular checkout web node 304 may communicate with identity services 306 and checkout orchestrator 210 for modular webpage rendering and other features. As such, the steps, interactions, and/or calls performed and/or exchanged as shown in diagram 300a may be performed between external clients and client devices of a service provider system, as well as the internal systems and components of the service provider system, such as service provider system 120 in system 100. Operations shown in diagram 300a may be performed in the course of rendering and streaming a login module on a webpage that may include other webpage modules and components configured to provide computing services to users.

Initially application 112 may request a webpage for a website through a navigation request, in-browser activity or action (e.g., a selection of a link or selectable icon, rerouting from another domain or webpage, etc.), and/or out-of-browser event including those from other applications. In the embodiment shown in diagram 300a, the webpage may be requested as a result of engaging in electronic transaction processing with another party, such as a merchant that may utilize the payment processing services of an online transaction processor or other online financial services provider. As such, the webpage request may correspond to a request to have a webpage and/or webpage data (e.g., assets, components, etc., for in-browser building of the webpage) sent to application 112 for processing and/or a display or other presentation to a user utilizing application 112. Thus, modular checkout web node 304 may be initiated and/or provided for webpage component streaming to application 112 when the webpage request is received at a gateway service or the like for the service provider's APIs, systems, and/or communications. At a step 2001, modular checkout web node 304 performs a routing and eligibility check for determination how whether the request is capable of being and eligible to be handled and processed for webpage loading in application 112.

The eligibility check at step 2001 may determine whether application 112 is authorized to or should receive the checkout webpage. This may include a risk and/or fraud assessment, validity check that application 112 is associated and/or engaged with the checkout, and/or other assessment to verify that the requester is a valid recipient of the webpage and not otherwise acting fraudulently (or has a known or inferred fraudulent history). In some embodiments, the eligibility check may utilize identity services 306 or other platforms for verification of user, device, or requester identity. Diagram 300a provides a flow where identity services 306 perform a verification of a user login prior to webpage component rendering for changes in the modular rendering of a webpage. At a step 2002, login module queries for the login module to be rendered and made by modular checkout web node 304 to checkout orchestrator 210. The login module queries may correspond to one or more calls to obtain data for rendering the login module including component assets, live data, operations or executables, and/or web code for the presentation of the login module.

At a step 2003, processing and downstream calls are made by checkout orchestrator 210 to one or more APIs, computing services, or other endpoint that may appropriately determine data for checkout orchestrator including domain-specific data. Downstream APIs and/or services may be called individually and, in an order, sequence, or manner determined using AI engine 134 from the requester, request itself and/or activities and input on previous webpages or with the website, and/or importance or prioritization of the webpage components and their corresponding data. However, checkout orchestrator 210 may also provide parallelization, such as parallel processing or executing/performing parallel processing jobs at the same or similar times instead of waiting for one job to finish and then starting on the next. Parallel processing of multiple jobs may improve the speed at which checkout orchestrator 210 is capable of processing the data when rendering the checkout webpage, and, when prioritizing webpage components for rendering in a user-and/or request-specific manner, such as based on request-specific data, may provide important and/or relevant webpage components in faster and more intuitive manner than conventional rendering processes. As such, the processing and downstream calls to obtain the data needed for the login module rendering (e.g., based on and responsive to login module queries received at step 2002) may be performed by checkout orchestrator 210 in the order prescribed by AI engine 134 when determining a prioritization and order for rendering the webpage components of the checkout webpage, and may also be performed in parallel to other processing and downstream calls for other webpage components.

At the conclusion of step 2003, the calls by checkout orchestrator 210 to downstream APIs and/or services, and further data processing for data necessary or utilized to render the login module is completed. At a step 2004, a response is sent from checkout orchestrator 210 to modular checkout web node 304 that includes the component-specific data for rendering the login module on the checkout webpage. Modular checkout web node 304 may execute a rendering engine or operation to render the login module for application 112, which may be based on the browser's and/or browser device's capabilities, configuration, and/or settings, and webpage code for an output or presentation of the module on a corresponding webpage may be determined. At a step 2005, modular checkout web node 304 then streams HTML or other deliverable webpage code to application 112, which may be done when the code is available for each modular component instead of waiting for a full-page render of the webpage. This may be done through multiple responses or calls to application 112 instead of a single call having a large data file or webpage code package that has been rendered in its entirety, thereby reducing rendering and loading time of certain webpage components and eliminating waiting times, bottleneck issues with large data files, and/or transmission errors with single calls that may cause a failure to load the entire page.

In diagram 300b of FIG. 3B, a successful login, either previously in another session or via a webpage component of another webpage, has been performed and the modular checkout webpage may then provide a “review your information”-type interface for user information confirmation during transaction processing. Diagram 300b follows similar calls and processing events to those that were performed with regard to diagram 300a but may correspond to a different modular component for the checkout webpage loaded based on the events (e.g., the login) occurring prior to or in correspondence with requesting and loading the checkout webpage in application 112. For example, with regard to data retrieval, rendering, and streaming of webpage code to application 112, diagrams 300a and 300b are very similar. Operations in diagram 300b perform a routing and eligibility check, at step 3001, and queries checkout orchestrator 210 based on the corresponding module to be rendered and presented on the webpage, at step 3002. Checkout orchestrator 210 then performs processing and downstream calls to downstream APIs and services acting as the unified interface for such data sources usable for webpage component rendering, at step 3003. Step 3003 results in webpage component data for rendering of the “review your information” section or field on the webpage being retrieved, which may be processed and sent to modular checkout web node 304 for rendering in a response, at step 3004. Modular checkout web node 304 then renders the webpage component as a webpage for presentation in a browser and/or on a device, and, at step 3005, HTML or other webpage code is streamed to application 112.

However, because different modules are to be rendered and loaded in application 112 for modular webpage rendering, streaming, and delivery, different downstream services and/or APIs may be called by checkout orchestrator 210. In this regard, checkout orchestrator 210, as well as modular checkout web node 304, may perform similar jobs and functions, and the processing by checkout orchestrator 210 and modular checkout web node 304 may be different and stream a differently rendered webpage component to application 112 during webpage loading. Further, diagrams 300a and 300b also differ with regard to the initial request webpage component request. In diagram 300b, an identity of a user has been determined or performed, and the call for webpage component loading may instead be received from an internal component, identity services 306, that confirms a successful login and requests that the checkout webpage load the corresponding module for the user and a “logged in” or verified user.

As such, selection of which modular component and performance of the corresponding calls from diagrams 300a and 300b may depend on the state of the checkout and/or information provided and available when receiving the request for the webpage from application 112. As such, the checkout webpage may be dynamic through the use of modular webpage components, which allows for rendering of user-specific and personalized webpages without requiring full page loads or reloads of other webpage components and their corresponding content that has been or is to be rendered on the webpage. Thus, without being required to be built in-browser from retrieved components but instead using a server-side rendering process, a webpage may be built to have different components based on the available data, actions or activities occurring with the webpage or on the website of the webpage, or the like so that the webpage may be customized and personalized for each user and corresponding output and presentation of the webpage.

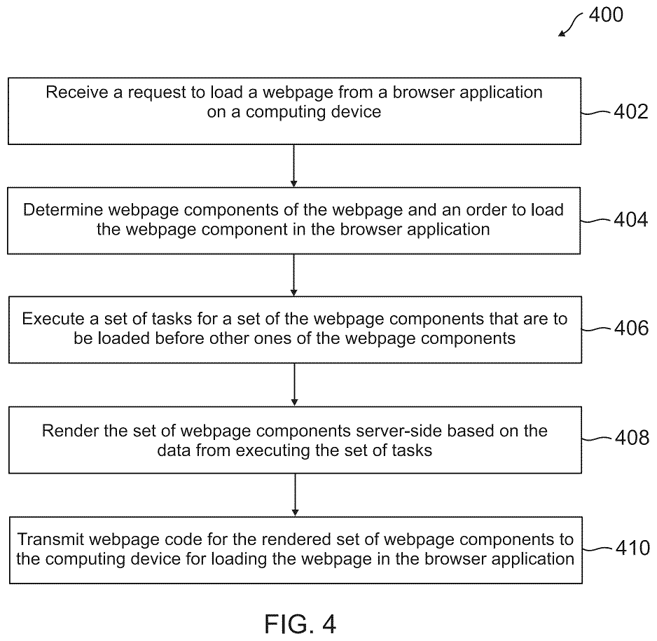

FIG. 4 is a flowchart 400 showing operations performed by modular webpage components for server-side rendering of deliverable webpage code, according to an embodiment. Note that one or more steps, processes, and methods described herein of flowchart 400 may be omitted, performed in a different sequence, or combined as desired or appropriate.

At step 402 of flowchart 400, a request to load a webpage is received from a browser application on a computing device. For example, in system 100 of FIG. 1, client device 110 may request that data for webpage/UI 115 be provided by service provider system 120 for a presentation in application 112 by transmitting request 113 to service provider system 120 via an API request or other call to an API of service applications 122. APIs of service applications 122 may include external, network facing APIs and/or other APIs that may be called by corresponding client-side software application (or applications of other devices, servers, or systems that may access to request rendered webpage data). In this regard, a client application, such as application 112, may receive input corresponding to a navigation event to and/or request to access and present a webpage for a website corresponding to service provider system 120. Request 113 may be received by service provider system 120 and handled for processing and webpage rendering by modular webpage platform 130. Although webpages and webpage rendering are discussed in reference to flowchart 400 and FIG. 4, it is understood that similar steps and processes of flowchart 400 may also be applied to and performed when rendering UIs and modular UI components for native software applications, as discussed herein.

At step 404, webpage components of the webpage and an order to load the webpage component in the browser application is determined. For modular webpage building and rendering, modular webpage components 131 may be accessed and/or loaded in local memory for use with webpage rendering from a data store, such as a component factory for executable processes and/or code for webpage components. In this regard, modular webpage components 131 may correspond to tasks 132 that are designated for execution and/or completion to properly load a webpage, such as a “job to be done” for webpage rendering for display in a client of a device. As such, when a webpage is requested, webpage components from modular webpage components 131 may be identified for rendering server-side and delivery of webpage code to the requesting client.

In some embodiments, a DOM file, document, or other data may provide information associated with a webpages content and structure, such as one or more of modular webpage components 131 used by and/or provided with the webpage. For example, a webpage design or DOM file for a modularly designed webpage may identify each module of the webpage, as well as the layout of the modules and/or any interactions or dependencies between the modules. This document or file may be used to determine the content to be rendered server-side for website presentation on client device 110.

With modularly designed webpages and/or webpages that may be rendered using modular component rendering, a webpage may have a corresponding structure, layout, or other organizational representation of the webpage. These representations may be provided by webpage structures 133, which may identify and provide the content and organization of the content on the webpages, such as the data, fields, processes, and the like that are to be presented on the webpages and/or provided through the webpages. In some embodiments, one or more of the webpages for the website being requested from service provider system 120 may use dynamic data and/or provide real-time and/or updateable data dynamically depending on changes to the underlying data and/or data availability. As such, modular webpage components 131 and/or webpage structures 133 may designate and/or identify, for the corresponding ones of tasks 132, the data that may be updated, changed, or determined in real-time and/or based on the request for the webpage (e.g., time or location-specific data that requires a call to another database, component, or application for live or real-time data).

Initially, webpage components for a modular webpage rendering and presentation may be rendered in either the fastest manner or according to an original rendering order set by one or more users, such as webpage developers or designers of the webpage. However, to provide more personalized webpage rendering on client devices of users, the order may be changed and/or reconfigured for the particular user. For example, AI engine 134 may include one or more AI models trained to predict a user prioritization or preference of rendering and presenting different webpage components in application 112 on client device 110. During checkout with a transaction processing webpage, a user may want to view a transaction total and payment source selection component and/or element(s) of the webpage first and as quickly as possible. Other users may want to see an account login screen and/or window immediately. Since each of modular webpage components 131 are modular and may be separately executed and/or executed in parallel, prioritization of certain components may be performed so as to provide those webpage components in a faster manner with less bandwidth usage and latency issues. As such, prioritization of component rendering may be user and/or request-specific and may depend on known or available information for the user or request at the time request 113 is made.

At step 406, a set of tasks for a set of the webpage components that are to be loaded before other ones of the webpage components is executed. In response to request 113, one or more of modular webpage components 131 may be identified for the corresponding ones of tasks 132 that are to be performed or executed based on a structure of the webpage to be rendered from webpage structures 133 and the order specifically determined for the request. The order of webpage component rendering may be customized and/or personalized for the requester such that two or more components, when reader for execution of their tasks, may be executed and rendered in parallel processes. As such, based on the order for component rendering, the corresponding ones of tasks 132 needed for execution to render the webpage elements (e.g., the data, code, executable, etc.) may be performed in order to determine and/or obtain the data necessary for rendering of that webpage component.

At step 408, the set of webpage components is rendered server-side based on the data from executing the set of tasks. A rendering engine for webpages may be used to render the webpage components as they would appear on and/or be presented by the client requesting the webpage, such as according to the operating system, browser application, etc. that has requested and/or will be displaying the webpage. The rendering engine may utilize a webpage rendering tool or operation to obtain the rendered data as would be output in a UI of application 112. Because modular webpage components 131 are modular, once one of modular webpage components 131 for the webpage has been rendered for the corresponding webpage request, the rendered webpage component may be served directly to the client for presentation, without slowdown from rendering of other components or the webpage in its entirety. As such, presentation of prioritized components may be performed more efficiently and faster than existing server-side rendering processes. The parallelization of webpage component rendering enables more than one component to be separately rendered to prevent further slowdown, and the order for rendering of the webpage components may be iterated through in this manner until completion of webpage rendering.

At step 410, webpage code for the rendered set of webpage components is transmitted to the computing device for loading the webpage in the browser application. In this regard, after server-side rendering 135 is performed, modular webpage platform 130 may require generation and/or extraction of deliverable code 136 that is usable by application 112 to output the visual data for the rendering of webpage/UI 115. Deliverable code 136 may correspond to HTML, CSS, or the like that may provide ready-made webpage code for webpage output, thereby removing the need for client-side webpage building and/or rendering (e.g., where webpage components may be fetched by the client and built in-browser and/or on-device). Deliverable code 136 may also correspond to multiple code snippets, data packages, or files, each corresponding to a separate component of the webpage to load, such as component code 116 may be sent to and received by client device 110 by service provider system 120 in multiple API calls each contain separate call data for the webpage code of the corresponding modular component.

Component code 116 may correspond to a checkout webpage for a transaction during a transaction processing flow on one of websites 124 of service provider system 120 or a merchant that may utilize the transaction processing services of service provider system 120. In this regard, component code 116 for checkout elements and fields critical to transaction review, approval, and/or payment information submission and verification may be rendered first and sent to client device 110 in multiple API calls for each corresponding checkout webpage component. Other webpage components associated with account histories, similar purchases, etc., may be rendered after and provided to client device 110. As such, component code 116 may be presented and output when received and from multiple calls and corresponding webpage code so that individual component delays or errors do not impact other components on the webpage, and the user may view the webpage in the quickest and more efficient manner available.

Note that while flowchart 400 is described with respect to a user viewing a webpage of a service provider, similar concepts, as discussed herein, can be used for rendering webpage components and modules for other types of webpages and/or webpage requesters.

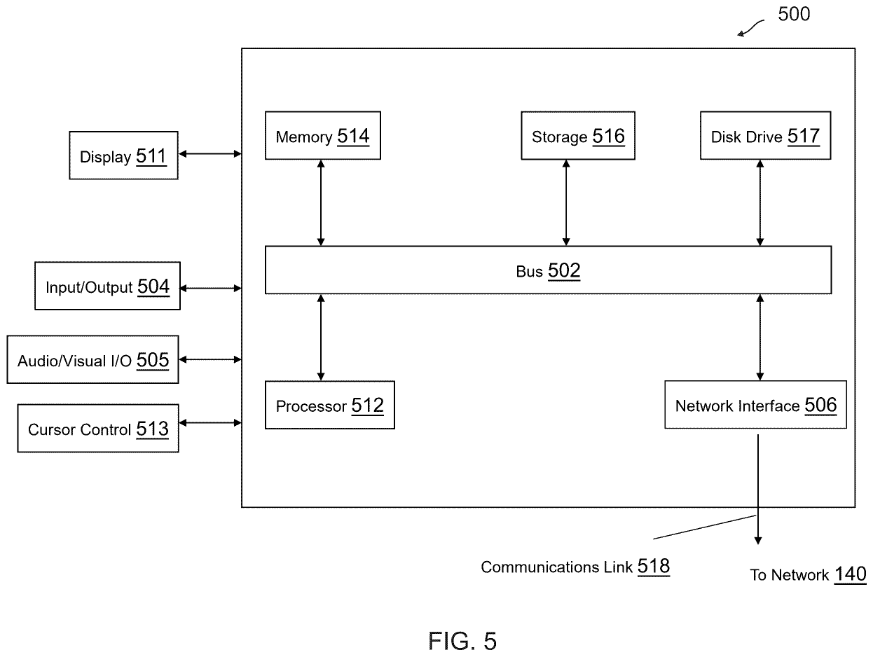

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations:
receiving, from a computing device, a request to load a webpage;
identifying a structure of the webpage that includes a plurality of webpage components associated with a plurality of tasks to be executed for a presentation of the webpage on the computing device;
determining an order to load the plurality of webpage components based at least on the request and the structure;
selecting a first set of webpage components from the plurality of webpage components that are to be loaded for the presentation of the webpage based on the order;
executing a first set of tasks from the plurality of tasks based on the first set of webpage components to be loaded, wherein the executing the first set of tasks is performed using data associated with the request;
rendering the first set of webpage components for the presentation based on the executed first set of executable tasks; and
transmitting webpage code for the rendered first set of webpage components to the computing device that enables the computing device to provide the presentation.

2. The system of claim 1, wherein the executing the first set of tasks comprises:
performing a server-side rendering of the webpage based on the plurality of webpage components, the plurality of tasks, and the order;
processing the first set of tasks during the server-side rendering based on the data associated with the request; and
generating the webpage code for the first set of webpage components based on the processing and prior to generating the webpage code for a second set of webpage components for the presentation of the webpage.

3. The system of claim 1, wherein the computing device is associated with a user or an account of the user being used for a checkout with a merchant, and wherein the order is further determined based on at least one of the user, the account, or the checkout.

4. The system of claim 3, wherein the order is further determined based on at least one of a historical use of one or more of the plurality of webpage components for the user or the account or a payment processing operation utilizable for the checkout.

5. The system of claim 1, wherein each of the plurality of webpage components is associated with a job to be completed by a user when the webpage is presented on the computing device for a computing service of a service provider associated with the webpage, and wherein the job is configured to be specific to the user based on the data associated with the request.

6. The system of claim 1, wherein each of the plurality of tasks is capable of being performed in parallel for rendering and loading the webpage on the computing device based on one or more system resources provided to each of the plurality of tasks by a webpage request handler, and wherein, after the executing the first set of tasks, the operations further comprise:
executing a second set of tasks based on the one or more system resources available to the webpage request handler after the executing the first set of tasks.

7. The system of claim 1, wherein the webpage code is generated from the rendering at a server of the system instead of being generated by a browser application on the computing device, and wherein the webpage code is usable by the computing device in place of client-side webpage assets for rendering the webpage by the browser application.

8. The system of claim 1, wherein the request comprises an application programming interface (API) request for the webpage responsive to a navigation event in an application on the computing device to the webpage, and wherein the operations further comprise:
transmitting an API response to the computing device that identifies the structure and the plurality of webpage components; and
receiving a plurality of API sub-requests associated with loading each of the plurality of webpage components for the webpage on the computing device,
wherein the webpage code is transmitted in response to at least one of the plurality of API sub-requests.

9. The system of claim 8, wherein the transmitting the webpage code comprises transmitting a portion of the webpage code for each of the plurality of webpage components responsive to each of the plurality of API sub-requests.

10. A method comprising:
receiving an application programming interface (API) request for a webpage component of a webpage from a computing device, wherein the webpage component comprises a portion of webpage data for the webpage rendered in the webpage component for a display of the webpage on the computing device;
determining a task associated with the webpage component that enables a server-side rendering of the webpage;
identifying request-specific data for the display of the webpage on the computing device based at least on the API request;
executing the task based at least on the request-specific data;
performing the server-side rendering of the webpage based at least on the executed task, wherein the server-side rendering generates webpage code for the display of the webpage on the computing device; and
transmitting, via an API response to the API request, the webpage code to the computing device that enables the computing device to the display the webpage.

11. The method of claim 10, wherein the task is a task of a plurality of tasks for rendering the webpage for the display.

12. The method of claim 11, wherein at least two of the plurality of tasks are executed using parallel processing jobs.

13. The method of claim 12, wherein the at least two of the plurality of tasks are selected for the parallel processing jobs based on a prioritization of the plurality of tasks for rendering the display of the webpage.

14. The method of claim 11, wherein each of the plurality of tasks utilizes a different API or a different computing service to be called for webpage component data used for the server-side rendering, and wherein the method further comprises:
obtaining the webpage component data at an orchestrator from a plurality of API calls to the different API or the different computing service for each of the plurality of tasks, wherein the orchestrator is configured to obtain the webpage component data for the server-side rendering of the webpage component and a plurality of other webpage components on the webpage.

15. The method of claim 14, wherein the orchestrator is further configured to provide a unified interface for a plurality of APIs and a plurality of services callable for webpage data when rendering a plurality of webpages, and wherein the orchestrator is connectable to a plurality of website servers for a plurality of websites including a website corresponding to the webpage requested.

16. The method of claim 10, wherein the request-specific data includes at least one of user data for a user associated with the computing device, account data for an account associated with the user or the computing device, or a website activity engaged in by the computing device with a website corresponding to the webpage, and wherein the request-specific data is usable to generate an output of the webpage component.

17. The method of claim 10, wherein the transmitting the webpage code comprises streaming the webpage code to the computing device once rendered from the server-side rendering independent of additional webpage code for additional webpage components being included with the webpage code transmitted via the API call.

18. The method of claim 10, wherein the webpage comprises a checkout webpage for a transaction, and wherein the webpage component comprises a transaction review component having updated transaction data that is processed for rendering first for the display of the checkout webpage.

19. A non-transitory machine-readable medium having stored thereon machine-readable instructions executable to cause a machine to perform operations comprising:
receiving a request for user interface (UI) data from an application on a client device;
determining a plurality of tasks to be executed for a presentation of the UI data in a UI of the application based on the request, wherein each task of the plurality of tasks is executable to determine data for rendering one or more of a plurality of UI components for the presentation of the UI data;
determining an order for rendering the one or more of the plurality of webpage components in the UI based on the request and the plurality of tasks to be executed;
executing one or more calls to one or more computing services for the data for rendering the one or more of the plurality of UI components;
rendering the one or more of the plurality of UI components using parallel processing for different ones of the plurality of tasks based on the plurality of tasks and the data; and
streaming the one or more of the plurality of UI components to the client device that enables the client device to provide the presentation of the UI data in the application as the one or more of the plurality of UI components are rendered from the parallel processing.

20. The non-transitory machine-readable medium of claim 19, wherein the UI comprises a checkout UI of a checkout processing flow for a transaction being processed in the application, and wherein the one or more of the plurality of UI components are selected for or omitted from rendering the presentation for the checkout processing flow based on information associated with the transaction or a user utilizing the checkout UI for the transaction.
